(19) United States
(12) Patent Application Publication
(10) Pub. No.: US 2025/0247189 A1
(43) Pub. Date: Jul. 31, 2025

(54) METHODS, DEVICES, AND COMPUTER READABLE MEDIUM FOR COMMUNICATION

(71) Applicant: NEC CORPORATION, Tokyo (JP)

(72) Inventors: Gang WANG, Beijing (CN); Yukai GAO, Beijing (CN); Peng GUAN, Beijing (CN)

(21) Appl. No.: 18/854,352

(22) PCT Filed: Apr. 15, 2022
(86) PCT No.: PCT/CN2022/087203

§ 371 Date: Oct. 4, 2024

(51) Int. Cl. H04L 5/00; H04B 7/06; H04L 41/16; H04W 8/22; H04W 24/08

(52) U.S. Cl. CPC H04L 5/0051; H04B 7/0626; H04L 41/16; H04W 8/22; H04W 24/08

(57) ABSTRACT

Embodiments of the present disclosure relate to methods, devices, and computer readable medium for communication. According to embodiments of the present disclosure, a network device transmits configuration information to a terminal device. The configuration information is associated with a determination of at least one set of RS resources. The terminal device determines a set of training reference signals for management of an AI/ML model based on the at least one set of RS resources. The terminal device updates the AI/ML model based on the set of training reference signals. In this way, the overhead can be reduced.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. For example, communication devices may employ an artificial intelligent/machine learning (AI/ML) model to improve communication qualities. The AI/ML model can be applied to different scenarios to achieve better performances.

### SUMMARY

In general, example embodiments of the present disclosure provide a solution for communication.

In a first aspect, there is provided a method for communication. The communication method comprises: receiving, at a terminal device, configuration information from a network device, wherein the configuration information comprises at least one set of reference signal (RS) resources; determining a set of training reference signals for management of an artificial intelligence/machine learning (AI/ML) model based on the at least one set of RS resources; and managing the AI/ML model based on the set of training reference signals.

In a second aspect, there is provided a method for communication. The communication method comprises: transmitting, at a network device, configuration information to a terminal device, wherein the configuration information comprises at least one set of reference signal (RS) resources; and transmitting, to the terminal device, a set of training reference signals for management of an artificial intelligence/machine learning (AI/ML) model based on the at least one set of RS resources.

In a third aspect, there is provided a terminal device. The terminal device comprises a processing unit; and a memory coupled to the processing unit and storing instructions thereon, the instructions, when executed by the processing unit, causing the terminal device to perform acts comprising: receiving configuration information from a network device, wherein the configuration information comprises at least one set of reference signal (RS) resources; determining a set of training reference signals for management of an artificial intelligence/machine learning (AI/ML) model based on the at least one set of RS resources; and managing the AI/ML model based on the set of training reference signals.

In a fourth aspect, there is provided a network device. The network device comprises a processing unit; and a memory coupled to the processing unit and storing instructions thereon, the instructions, when executed by the processing unit, causing the network device to perform acts comprising: transmitting configuration information to a terminal device, wherein the configuration information comprises at least one set of reference signal (RS) resources; and transmitting, to the terminal device, a set of training reference signals for management of an artificial intelligence/machine learning (AI/ML) model based on the at least one set of RS resources.

In a fifth aspect, there is provided a computer readable medium having instructions stored thereon, the instructions, when executed on at least one processor, causing the at least one processor to carry out the method according to the first or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3 illustrates a signaling flow for communications according to some embodiments of the present disclosure;

FIG. 4 is a flowchart of an example method in accordance with an embodiment of the present disclosure;

FIG. 5 is a flowchart of an example method in accordance with an embodiment of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, the AI/ML model can be applied to different scenarios to achieve better performances. In some embodiments, the AI/ML model can be implemented at the network device side. Alternatively, the AI/ML model can be implemented at the terminal device side. In other embodiments, the AI/ML model can be implemented at both the network device and the terminal device.

For example, the terminal devices can perform the beam management on the AI/ML model. In this case, the terminal device can measure a part of candidate beam pairs and use AI or ML to estimate qualities for all candidate beam pairs. Massive MIMO (mMIMO) and beamforming are widely used in the telecom industry. Terms “beamforming” and “mMIMO” are sometimes used interchangeably. In general, beamforming uses multiple antennas to control the direction of a wave-front by appropriately weighting the magnitude and phase of individual antenna signals in an array of multiple antennas. The most commonly seen definition is that mMIMO is a system where the number of antennas exceeds the number of users. The coverage is beam-based in 5G, not cell based. There is no cell-level reference channel from where the coverage of the cell could be measured. Instead, each cell has one or multiple synchronization signal and physical broadcast channel block (SSB) beams. SSB beams are static, or semi-static, always pointing to the same direction. They form a grid of beams covering the whole cell area. The user equipment (UE) searches for and measures the beams, maintaining a set of candidate beams. The candidate set of beams may contain beams from multiple cells. With 5G millimeter wave (mmWave) enabling directional communication with a larger number of antenna elements and providing an additional beamforming gain, efficient management of beams—where UE and gNB regularly identify the optimal beams to work on at any given point of time—has become crucial.

Additionally, the terminal device can perform CSI feedback based on the AI/ML model. In this situation, the original CSI information can be compressed by an AI encoder located in the terminal device, and recovered by an AI decoder located in the network device. The AI/ML model can also be sued for reference signal (RS) overhead reduction. For example, the terminal device can use a new RS pattern, such as, lower density DMRS, less CSI-RS port.

The necessary data required for the online model management (especially model training) are difficult to be reported by the UE, e.g., channel impulse response (CIR) required for channel state information (CSI) compression and beam qualities of all beams required for beam prediction. Furthermore, the data may need to be reported many times (e.g., periodic reporting), which may cause the huge overhead of reporting resource. Additionally, considering the improvement of the UE processing capacity, it may be better that the online model management is completed in the UE side.

The UE-based online model management requires the UE to construct corresponding data set. For example, in order to achieve model training, the UE needs to construct the training data set (note: the training data set here includes the validation data set). And the data contained in the training data set needs to be calculated and obtained according to the corresponding RS (e.g., CSI-RS, SSB). For convenience, the RS can be called as the training RS. Therefore, in order to realize the online model management or the online data set construction, the training RS is indispensable.

Further, for the online model management under different use cases, the requirements for the training RS may different or specific. How to reasonably configure or determine (collectively referred to as “obtain”) the training RS is obviously important.

In order to solve at least part of the above or other potential problems, solutions on improving the AI/ML model are proposed. According to embodiments of the present disclosure, a network device transmits configuration information to a terminal device. The configuration information comprises at least one set of RS resources. The terminal device determines a set of training reference signals for management of an AI/ML model based on the at least one set of RS resources. The terminal device updates the AI/ML model based on the set of training reference signals. In this way, the overhead can be reduced.

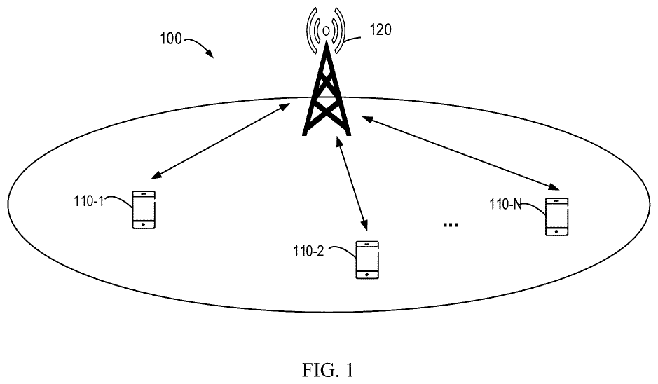

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number. The terminal devices 110 can communicate with each other.

The communication system 100 further comprises a network device. In the communication system 100, the network device 120 and the terminal devices 110 can communicate data and control information to each other. The numbers of terminal devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

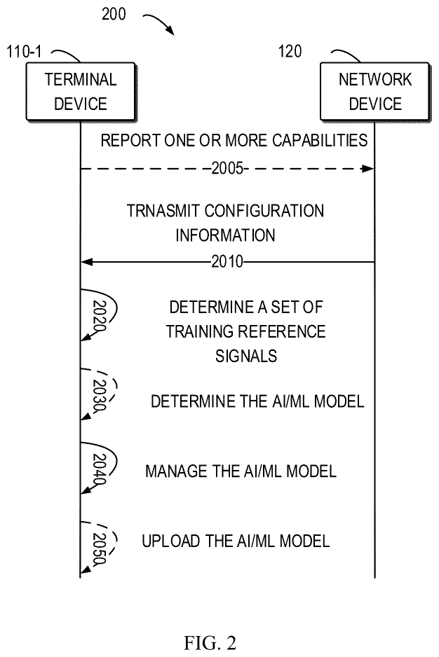

Embodiments of the present disclosure will be described in detail below. Reference is first made to FIG. 2, which shows a signaling chart illustrating process 200 between the terminal device and the network device according to some example embodiments of the present disclosure. Only for the purpose of discussion, the process 200 will be described with reference to FIG. 1. The process 200 may involve the terminal device 110-1 and the network device 120 in FIG. 1. In some embodiments, the process 200 can be applied in the AI/ML-based beam management. Alternatively, the process 200 can be applied in the AI/ML-based CSI feedback. In other embodiments, the process 200 can be applied in the AI/ML-based DMRS. In some embodiments, the process 200 can be applied in the AI/ML-based CSI-RS.

In some embodiments, the terminal device 110-1 may report 2005 one or more capabilities of the terminal device 110-1 to the network device 120. The one or more capabilities at least indicate that the terminal device 110-1 supports a data processing model. The data processing model can be an AI/ML model. The term “AI/ML model” used herein can refer to a program or algorithm that utilizes a set of data that enables it to recognize certain patterns. This allows it to reach a conclusion or make a prediction when provided with sufficient information. Generally, the AI/ML model can be a mathematical algorithm that is “trained” using data and human expert input to replicate a decision an expert would make when provided that same information.

In some embodiments, the capabilities can indicate a capability of supporting AI/ML. In some embodiments, the capabilities can indicate a capability of supporting beam management based on AI/ML. Alternatively or in addition, the capabilities can indicate a capability of supporting CSI feedback based on AI/ML. Additionally, the capabilities may indicate that the terminal device 110-1 supports a capability of supporting DMRS based on AI/ML. In some other embodiments, the capabilities may indicate that the terminal device 110-1 supports a capability of supporting CSI-RS based on AI/ML. In some embodiments, the capabilities may comprise a first capability. In some embodiments, the first capability may indicate a first time delay of processing AI/ML related data. Alternatively or in addition, the first capability may indicate a second time delay of updating the AI/ML model.

The network device 120 transmits 2010 configuration information to the terminal device 110-1. The configuration information is associated with determining at least one set of RS resources. In other words, the configuration information may explicitly comprise at least one set of RS resources. Alternatively, the configuration information may implicitly comprise the at least one set of RS resources. The configuration information used herein can refer to the configuration information which is provided to the terminal device by the network device or a serving cell via control signaling. For example, the configuration information can refer to a RRC configuration provided to the terminal device by the network device or the serving cell. In some embodiments, the control signaling may be RRC signaling. Alternatively, the control signaling may be MAC CE signaling. In other embodiments, the control signaling may be DCI signaling.

The terminal device 110-1 determines 2020 a set of training reference signals for management of an AI/ML model based on the at least one set of RS resources. The term “training reference signal” used herein can refer to the RS applied to construct the data set (e.g., training data set, validation data set, testing data set) that is used for AI/ML model management (e.g., model training, model monitoring, model updating).

In some embodiments, the network device 120 may transmit a downlink (DL) bandwidth part (BWP) configuration to the terminal device 110-1. In other words, the configuration information may be the DL BWP configuration. In this case, in some embodiments, the downlink bandwidth part configuration may comprise a training configuration indicating at least one set of RS resources. Alternatively, the downlink bandwidth part configuration may comprise a radio link monitoring configuration indicating the at least one set of RS resources. For example, considering the capability (i.e., support online training) of the terminal device 110-1, the set of training reference signals can be configured as the dedicated (or UE specific) parameter of a DL BWP or carrier component (CC). The training RS includes one or more RS resource sets which includes one or more RS resources. For example, for the terminal device 110-1, a configuration for training (e.g., TrainingConfig, ModelConfig) may be configured in a DL BWP. In some embodiments, the training RS may be configured in the training configuration. Table 1 below shows an example of the BWP DL configuration. Alternatively, the training RS can be configured in radio link monitoring configuration. Table 2 below shows an example of the radio link monitoring configuration.

TABLE 1

| | |
|---|---|
| BWP-DownlinkDedicated ::= | SEQUENCE { [symbol] |
| pdcch-Config | SetupRelease { PDCCH-Config } |
| pdsch-Config | SetupRelease ( PDSCH-Config } |
| sps-Config | SetupRelease { SPS-Config } |
| TrainingConfig | SetupRelease { TrainingConfig } [symbol] |
| radioLinkMonitoringConfig | SetupRelease { RadioLinkMonitoringConfig } |

TABLE 2

| RadioLinkMonitoringConfig ::= | SEQUEN [symbol] |
|---|---|
| failureDetectionResourcesToAddModList | |
| failureDetectionResourcesToReleaseList | |
| beamFailureInstanceMaxCount | |
| beamFailureDetectionTimer | |
| . . . [symbol] | |
| } [symbol] | |
| [symbol] | |
| TrainingRS [symbol] | |
| [symbol] | |
| RadioLinkMonitoringRS ::= | SEQUEN [symbol] |
| radioLinkMonitoringRS-Id | Ra [symbol] |
| purpose | EN [symbol] |
| detectionResource | CH [symbol] |

```
    ssb-Index
    csi-RS-Index
  }, [symbol]
  . . . [symbol]
} [symbol] [symbol]
indicates data missing or illegible when filed
```

In some embodiments, the configuration information may be transmitted in a radio resource control (RRC) signaling. Alternatively, the configuration information may be transmitted in media access control control element (MAC CE). In some other embodiments, the configuration information may be transmitted in downlink control information (DCI).

In some embodiments, the set of training RS may be one or more of: a set of CSI-RSs, a set of SSBs, a set of positioning reference signals (PRSs), or a setoff sounding reference signals (SRSs). For example, if the training of the AI/ML model relates to CSI feedback enhancement (e.g., CSI compression, CSI prediction), CSI-RS overhead reduction may need to collect data based on CSI-RS. The training of the AI/ML model related to positioning may need to collect data based on CSI-RS, PRS or SRS. The training of the AI/ML model related to beam management needs to collect data based on CSI-RS or SSB.

Alternatively, the network device 120 may transmit a configuration of CSI report to the terminal device 110-1. In other words, the configuration information may comprise the configuration of CSI report. In this case, in some embodiments, the configuration of CSI report indicates the at least one set of RS resources. Alternatively, the configuration of CSI report indicates a report quantity which indicates that the CSI reported is not required to be reported. For example, the set of training reference signals can be triggered by configuring, activating or indicating a CSI report associated with the set of training reference signals. In some embodiments, the set of training reference signals may be configured in the configuration of the CSI report (i.e., CSI-ReportConfig). Alternatively or in addition, the set of training reference signals may be configured in CSI-ResourceConfig in CSI-ReportConfig. In some embodiments, since the set of training reference signals is triggered based on the CSI report and the information obtained by the set of training reference signals does not need to be reported, the terminal device 110-1 may expect that the report quantity of the CSI report is set to “None”, that is, that CSI report does not require anything to be reported. The time domain type of the CSI report can be periodic (P), semi-persistent (SP) or aperiodic (AP). In some embodiments, period of the CSI-RS/SSB resource may configured by the network device 120. For example, it can be determined based on the above mentioned first capability reported by the terminal device 110-1. As discussed above, the first capability may be used to indicate the time delay of processing AI/ML related data and (or) AI/ML model training/updating. For example, the period is higher than or equal to the time delay indicated by the first capability. Table 3 below shows an example of the configuration of CSI report.

TABLE 3

| | |
|---|---|
| CSI-ReportConfig ::= | SEQUENCE { [symbol] |

| | |
|---|---|
| reportConfigId | CSI-ReportConfigId, [symbol] |
| carrier | ServCellIndex |
| resourcesForChannelMeasurement | CSI-ResourceConfigId, |
| csi-IM-ResourcesForInterference | CSI-ResourceConfigId |
| nzp-CSI-RS-ResourcesForInterference | CSI-ResourceConfigId |
| reportConfigType | CHOICE { [symbol] |
| periodic | SEQUENCE { [symbol] |
| reportSlotConfig | CSI-ReportPer [symbol] |
| pucch-CSI-ResourceList | SEQUENCE {SIZ [symbol] |
| }, [symbol] | |
| semiPersistentOnPUCCH | SEQUENCE { [symbol] |
| reportSlotConfig | CSI-ReportPer [symbol] |
| } | |
| pucch-CSI-ResourceList | SEQUENCE {SIZ [symbol] |
| }, [symbol] | |
| semiPersistentOnPUSCH | SEQUENCE { [symbol] |
| reportSlotConfig | ENUMERATED {s [symbol] |
| reportSlotOffsetList | SEQUENCE {SIZE {1 [symbol] |
| p0alpha | P0-PUSCH-Alph [symbol] |
| }, [symbol] | |
| aperiodic | SEQUENCE { [symbol] |
| reportSlotOffsetList | SEQUENCE {SIZE {1 [symbol] |
| } [symbol] | |
| }, [symbol] | |
| reportQuantity | CHOICE { [symbol] |
| none | NULL, [symbol] |
| cri-RI-PMI-CQI | NULL, [symbol] |
| cri-RI-i1 | NULL, [symbol] |
| cri-RI-i1-CQI | SEQUENCE { [symbol] |

[symbol]

indicates data missing or illegible when filed

In some embodiments, the terminal device 110-1 may determine a set of reference signals for a set of candidate beams based on the set of training reference signals. For example, if the terminal device 110-1 is not configured with the set of reference signals for the set of candidate beams, the terminal device 110-1 may determine the set of reference signals for the set of candidate beams based on the set of training reference signals. Alternatively, if the terminal device 110-1 is configured with the set of training reference signals, the terminal device 110-1 may determine the set of reference signals for the set of candidate beams based on the set of training reference signals. In some other embodiments, if the set of training reference signals is applied for the AI/ML model corresponding to beam management, the terminal device 110-1 may determine the set of reference signals for the set of candidate beams based on the set of training reference signals. In this way, it can reduce overhead caused by configuring the RSs of candidate beams.

In some embodiments, the terminal device 110-1 may determine the at least one set of RS resources associated with a CSI report. For example, in some embodiments, if the configuration information comprises an enable parameter which indicates the terminal device to determine the set of training reference signals, the terminal device 110-1 may determine the at least one set of RS resources associated with the CSI report. Alternatively, if the configuration information does not comprise the set of RS resources, the terminal device 110-1 may determine the at least one set of RS resources associated with the CSI report. The terminal device 110-1 may also determine the set of training reference signals based on the at least one set of RS resource. For example, the terminal device 110-1 may determine the set of training reference signals based on CSI-RS/SSB resource(s) associated with the CSI report. Further, the CSI-RS/SSB resource and the CSI report need to satisfy the following criteria.

In some embodiments, if the AI/ML model corresponds to at least one of: CSI-feedback enhancement, CSI-RS overhead reduction, or positioning, the CSI report may comprise CSI or compressed CSI. The CSI report comprising the CSI or compressed CSI means that the CSI report is configured for reporting CSI. For example, for determining the set of training reference signals applied for the AI/ML model corresponding to CSI feedback enhancement, CSI-RS overhead reduction or positioning, the CSI report may be configured for reporting CSI (e.g., CSI-RS resource indicator (CRI), rand indicator (RI), lawful intercept (LI), precoding matrix indicator (PMI), channel quality indicator (CQI)) or compressed CSI (e.g., compressed bits). For example, the report quantity of the CSI report is set to “CRI-RI-PMI-CQI” or “compressed bits”.

Alternatively, if the AI/ML model corresponds to beam management, the CSI report may comprise beam information or may be configured not to report. For example, for determining the set of training reference signals applied for models corresponding to beam management, the CSI report may be configured for reporting beam (i.e., beam and corresponding beam quality) or none. For example, the report quantity of the CSI report is set to “CRI-L1-RSRP”, “SSBRI-L1-RSRP” or “None”.

In some embodiments, the terminal device 110-1 may determine the at least one set of RS resources based on the CSI-RS/SSB resources that are used as the RSs of candidate beams, especially for determining the training RS applied for models corresponding to beam management. Specially, the reference signals of candidate beams refer to the set of P CSI-RS/SSB resources configured by candidateBeamRSList1 or candidateBeamRSList2.

In some embodiments, the time domain type of the CSI-RS resource is P or SP. If the time domain type of the CSI-RS resource associated with the CSI report (e.g., AP CSI report) is AP, the training RS can be determined according to a P CSI-RS resource or SSB resource associated with the AP CSI-RS resource. For example, it can be a periodic RS (e.g., CSI-RS, SSB) resource configured with Quasi-co location (QCL)-Type set to ‘typeD’ in the TCI state or the QCL assumption associated with the AP CSI-RS resource, which can be called “a periodic QCL-TypeD RS of the AP CSI-RS resource” for short. In some embodiments, the CSI-RS/SSB resource may be configured for channel measurement.

Different use cases (or different AI/ML models applied for different functions) have different requirements for training data (e.g., input and output). In order to obtain the training data required for a specific use case, the training RS (e.g., CSI-RS, SSB) may need to satisfying some criteria, that is, if the CSI-RS or (and) SSB resource(s) are configured as the training RS, the CSI-RS or SSB resource(s) need to satisfying the some criteria. Examples of the criteria are described below.

For example, for CSI feedback enhancement (e.g., CSI compression) and positioning (i.e., for determining the set of training reference signals applied for the AI/ML model corresponding to or applied for CSI feedback enhancement and positioning), the channel information in all resource elements (REs) within a slot may need to be used as training data of the AI/ML model for CSI feedback enhancement.

In some embodiments, if the AI/ML model corresponds to CSI feedback enhancement, the at least one set of RS resources may fulfill a first condition where reference signal resources in the at least one set of RS resources occupy a most number of resource elements within a slot or a physical resource block. For example, in order to obtain the most complete and accurate channel information (in all REs within a slot), the CSI-RS resource may occupy the most number of REs within a slot/PRB. For example, assuming that the maximum number of (antenna) ports of the CSI-RS that can be supported (MaxNumPortofCSI-RS for short) is 32, the CSI-RS resource(s) need to be configured with 32 ports and fD-CDM2 (i.e., type of CDM). Alternatively or in addition, if the AI/ML model corresponds to CSI feedback enhancement, the at least one set of RS resources may fulfill a second condition where a number of ports of the at least one set of RS resources equals to a maximum number of ports for CSI-RS. In other words, the number of ports of the CSI-RS resource may equal to MaxNumPortofCSI-RS. In some other embodiments, if the AI/ML model corresponds to CSI feedback enhancement, the at least one set of RS resources may fulfill a third condition where the number of ports of the at least one set of RS resources is not smaller than a first threshold number. For example, the number of ports of the CSI-RS resource CSI-RS may be higher than or equal to a first threshold. The first threshold refers to a number of ports (e.g., 1, 2, 4, 8, 12, 16, 24, 32) and is lower than or equal to MaxNumPortofCSI-RS.

In some embodiments, if the AI/ML model corresponds to CSI-RS overhead reduction, the at least one set of RS resources may fulfill a fourth condition where the number of ports of the at least one set of RS resources is not smaller than a maximum number of ports that the AI/ML model applied for CSI overhead reduction. For example, for CSI-RS overhead reduction, the number of ports of the CSI-RS resource may be higher than or equal to the maximum number of ports that the AI/ML model(s) applied for CSI overhead reduction can estimate. For example, there are 2 models corresponding to CSI overhead reduction. Outputs of the 2 models are 8 ports and 16 ports respectively, i.e., they can estimate the CSIs corresponding to 8 ports and 16 ports respectively. In this case, the number of ports of the CSI-RS resource is configured as 16. Alternatively, if the AI/ML model corresponds to CSI-RS overhead reduction, the at least one set of RS resources may fulfill a fifth condition where the number of ports of the at least one set of RS resources is a first predetermined number. For example, the number of ports of the CSI-RS resource may equal to MaxNumPortofCSI-RS.

Alternatively, if the AI/ML model corresponds to beam management, the at least one set of RS resources may fulfill a sixth condition where the number of reference signal resources in the at least one set of RS resources is not smaller than a maximum number of beam that the AI/ML model applied for beam prediction. For example, for beam management, the set of training reference signals may include one or more CSI-RS resource sets configured with repetition (a higher layer parameter). Furthermore, in order to save unnecessary CSI-RS overhead, the number of ports of the CSI-RS resource may be 1 or 2. The training RS needs to include at least N CSI-RS/SSB resource(s). In some embodiments, the value of N is higher than or equal to the maximum number of beams that the AI/ML model(s) applied for beam prediction can estimate. For example, there are 2 models applied for beam prediction. Outputs of the 2 models are 32 beams and 64 beams respectively, i.e., they can estimate the beam qualities of the 32 beams and 64 beams respectively. In this case, the training RS need to include 64 beams. Alternatively, if the AI/ML model corresponds to beam management, the at least one set of RS resources may fulfill a seventh condition where the number of RS resources equals to a maximum number of beams that the terminal device supports. For example, the value of N may equal to the maximum number of beams that can be supported, for example, 64 beams. In some embodiments, if the AI/ML model corresponds to beam management, the at least one set of RS resources may fulfill an eighth condition where the number of reference signal resources equals to a maximum number of reference signal resources that the terminal device supports. For example, the value of N may equal to the maximum number of CSI-RS/SSB resources that can be supported, for example, 192 CSI-RS resources.

In some embodiments, the terminal device 110-1 may determine 2030 the AI/ML model based on model information associated with the set of training reference signals. For example, the set of training reference signals or the CSI report (i.e., the CSI report used to trigger the training RS) may be associated with a model information. The model information may be used to indicate the AI/ML model to which the set of training reference signals is applied. In some embodiments, the model information may comprise one or more indicators (indexes or IDs) of one or more AI/ML models. Alternatively, the model information may comprise one or more indicators of one or more AI/ML model groups including a set of AI/ML models. In some other embodiments, the model information may comprise an indicator of one AI/ML model. In this case, the terminal device 110-1 may need to determine all models to which the set of training reference signals is applied based on the indicated AI/ML model. For example, all AI/ML models belong to the same model group but only one out of the model group is indicated.

Alternatively, the terminal device 110-1 may determine model information associated with the set of training reference signals based on usage information associated with the set of training reference signals. In this case, the terminal device 110-1 may determine 2030 the AI/ML model based on the model information. For example, the set training reference signals or the CSI report may be associated with usage information. The usage information can be used to indicate the usage (or purpose, function) of the set of training reference signals, e.g., CSI feedback (CSI compression, CSI prediction), CSI overhead reduction, beam management (beam prediction in spatial/time domain) or positioning. The terminal device 110-1 can then determine the model information according to the models corresponding to the usage (or the models required to complete the function). In some embodiments, if the terminal device 110-1 is not indicated with the model information, terminal device 110-1 can determine the model information based on the usage information.

In some embodiments, the configuration information may comprise a configuration of a CSI report. In this case, the terminal device 110-1 may determine the AI/ML model based on a report quantity of the CSI report. In other words, the terminal device 110-1 can determine which AI/ML model the set of training reference signals is applied for based on the report quantity of the CSI report that is used to trigger the set of training reference signals. For example, if the CSI report is configured for reporting the CSI or compressed bits, the terminal device 110-1 can assume that the set of training reference signals is applied to the models corresponding to CSI feedback enhancement, CSI-RS overhead reduction or position. Alternatively, if the CSI report is configured for reporting beam quality or none, the terminal device 110-1 can assume the training RS is applied to the models corresponding to beam management. In some other embodiments, which of the models the training RS is applied to depends on the implementation of the UE side.

The terminal device 110-1 manages 2040 the AI/ML model based on the set of training reference signals. For example, the terminal device 110-1 may update the AI/ML model based on the set of training reference signals. Alternatively, the terminal device 110-1 may train the AI/ML model based on the set of training reference signals. In other embodiments, the terminal device 110-1 may test the AI/ML model based on the set of training reference signals.

Considering the set of training reference signals is applied to construct the training data set, and the training set may be applied for model training or model updating. Therefore, the set of training reference signals may be associated with some information related to model training or model updating. In some embodiments, the configuration information comprises a data set size or a step size. The data set size may indicate a size of data set. The step size may indicate a frequency of updating the AI/ML model. In this case, the terminal device 110-1 may determine the size of data set and/or the frequency of updating corresponding to the AI/ML model based on the configuration information. For example, the data set size or the step size can refer to an integer that is larger than or equal to 0. For example, assuming that the size and the step size are set to 10 and 2 respectively. If the set of training reference signal is used to construct the training data set, the terminal device 110-1 may need to collect 10 data to perform model training. And after updating 2 data out of the 10 data each time, the terminal device 110-1 may perform the next training (i.e., model updating). “1 data” means that a CSI-RS/SSB transmission corresponding to the P/SP CSI-RS/SSB resource set(s) used as the training RS.

Alternatively, the data set size or the step size can refer to a duration, which may be integral multiple of the period of the CSI-RS/SSB resource set used as the training RS. For example, the terminal device 110-1 may construct the training data set by using the CSI-RS/SSB resources during the duration corresponding to the data set size and perform model training. And, the terminal device 110-1 may update the training data set by using the CSI-RS/SSB resources during the duration corresponding to the step size and perform model updating. In some embodiments, the terminal device 110-1 may report a second capability and/or a third capability. The second capability may indicate a minimum size of the data set required by the terminal device 110-1 to perform training. The third capability may indicate a maximum size of the data set required by the terminal device 110-1 to perform AI/ML model training. In this case, the network device 120 may can determine the data set size based on the second capability and/or the third capability reported by the terminal device 110-1. Alternatively, the terminal device 110-1 may report to the network device 120 a fourth capability indicating a minimum delay required by the terminal device 110-1 to perform AI/ML model training. In this case, the network device 120 may determine the data set size based on the fourth capability.

In some embodiments, the terminal device 110-1 or the network device 120 can apply the trained or updated AI/ML model from the symbol after a predefined time after receiving the last training RS within or during the duration indicated by the data set size or the step size. The predefined time may be determined according to at least one of the fourth capability, a fifth capability indicating the time delay of uploading or downloading model (from the edge cloud or core network). In this way, the terminal device can clearly know when to construct the training data set, model training and model updating. And the network device can know when to obtain the trained or updated model without indication from the UE.

In some embodiments, the configuration information comprises second information which indicates a type of the set of training reference signals. For example, the training RS (or the CSI report) may be associated with the second information. The second information can be used to indicate the type of the training RS, e.g., training, validation, testing. In other words, it is used to indicate which process is the training RS applied to in model management, e.g., model training, model updating, model monitoring. For example, if the terminal device 110-1 is provided with the second information indicating model training (or updating), the terminal device 110-1 can assume that the training RS is used as the RS applied for perform model training/updating. If the terminal device 110-1 is provided with the second information indicating model monitoring, the terminal device 110-1 can assume that the training RS is used as the (monitoring) RS applied for perform model monitoring. It means that the terminal device 110-1 can determine which processes in beam management need to be performed according to the second information.

In some embodiments, the terminal device 110-1 may determine a type of management of the AI/ML model based on the second information. In some embodiments, the type of management of the AI/ML model may comprise updating the AI/ML model. Alternatively or in addition, the type of management of the AI/ML model may comprise monitoring the AI/ML model. In some other embodiments, the type of management of the AI/ML model may comprise testing the AI/ML model. The type of management of the AI/ML model may also comprise training the AI/ML model. For example, the terminal device 110-1 can determine the type of the training RS according to the data set size or the step size associated with the training RS. Specifically, if the terminal device 110-1 is provided with the data set size or the step size, the UE can assume that the training RS is used as the RS applied for perform model training/updating, otherwise, the terminal device 110-1 can assume that the training RS is used as the (monitoring) RS applied for perform model monitoring. In this way, the terminal device can clearly know the type of the training RS, e.g., which kind of data set is the training RS applied to construct, which process is the training RS applied to in model management.

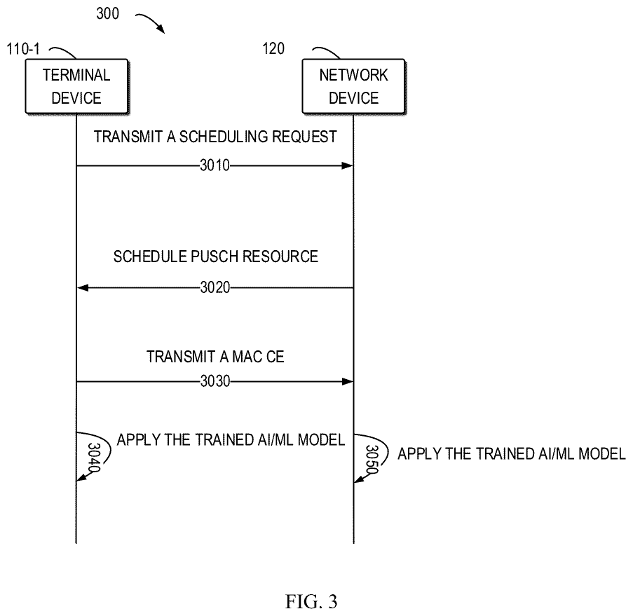

In some embodiments, a mechanism similar to beam failure recovery (BFR) reporting mechanism (especially for second cell, SCell) can be considered. For example, as shown in FIG. 3, the terminal device 110-1 may transmit 3010 a scheduling request (SR) to the network device 120. For example, the terminal device 110-1 can use a PUCCH transmission carrying a new SR to indicate the event that the model is trained/updated or the model performance is deteriorated. The new SR may correspond to a dedicated SR ID of the event.

The network device 120 may schedule 3020 PUSCH resources. For example, after receiving the PUCCH, the network device 120 can schedule UL resource (PUSCH) for the terminal device 110-1. And the terminal device 110-1 can report the information related to the trained/updated/deteriorated model in the scheduled PUSCH resource.

The terminal device 110-1 may transmit 3030 a MAC CE to the network device 120. For example, a new MAC-CE can be introduced. The MAC-CE may be used to indicate at least one of the model information corresponding to the trained/updated/deteriorated model, and third information. The third information may be used to indicate the type (e.g., trained, updated or deteriorated) corresponding to model indicated by the MAC-CE. In other words, the terminal device 110-1 can transmit the MAC-CE in the scheduled PUSCH resource to inform the network device 120 the trained/updated/deteriorated AI/ML model.

After K (K>=0) symbols from a last symbol of a PDCCH reception with a DCI format scheduling a PUSCH transmission with a same HARQ process number as for the transmission of the first PUSCH and having a toggled NDI field value, the terminal device 110-1 and the network device 120 may apply 3040/3050 the managed AI/ML model. Alternatively, the terminal device 110-1 and the network device 120 may stop applying the managed AI/ML model. For example, the terminal device 110-1 and the network device 120 can assume that the indicated model (e.g., the deteriorated model indicated by the MAC-CE) cannot be applied, or the model failures, or the model is invalid.

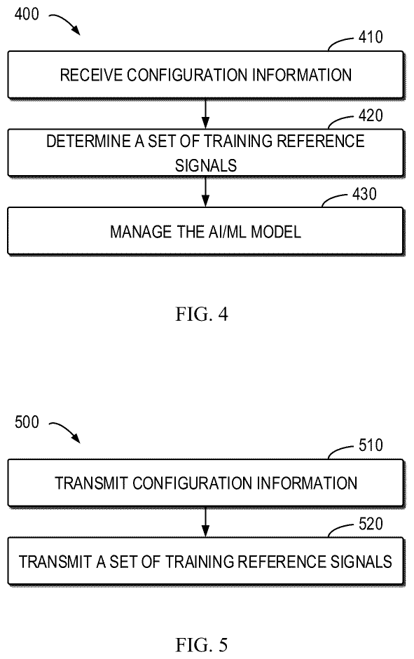

FIG. 4 shows a flowchart of an example method 400 in accordance with an embodiment of the present disclosure. The method 400 can be implemented at any suitable devices. Only for the purpose of illustrations, the method 400 can be implemented at a terminal device 110-1 as shown in FIG. 1.

In some embodiments, the terminal device 110-1 may report one or more capabilities of the terminal device 110-1 to the network device 120. The one or more capabilities at least indicate that the terminal device 110-1 supports a data processing model. The data processing model can be an AI/ML model. The term “AI/ML model” used herein can refer to a program or algorithm that utilizes a set of data that enables it to recognize certain patterns. This allows it to reach a conclusion or make a prediction when provided with sufficient information. Generally, the AI/ML model can be a mathematical algorithm that is “trained” using data and human expert input to replicate a decision an expert would make when provided that same information.

In some embodiments, the capabilities can indicate a capability of supporting AI/ML. In some embodiments, the capabilities can indicate a capability of supporting beam management based on AI/ML. Alternatively or in addition, the capabilities can indicate a capability of supporting CSI feedback based on AI/ML. Additionally, the capabilities may indicate that the terminal device 110-1 supports a capability of supporting DMRS based on AI/ML. In some other embodiments, the capabilities may indicate that the terminal device 110-1 supports a capability of supporting CSI-RS based on AI/ML. In some embodiments, the capabilities may comprise a first capability. In some embodiments, the first capability may indicate a first time delay of processing AI/ML related data. Alternatively or in addition, the first capability may indicate a second time delay of updating the AI/ML model.

At block 410, the terminal device 110-1 receives configuration information from the network device 120. The configuration information comprises at least one set of RS resources.

At block 420, the terminal device 110-1 determines a set of training reference signals for management of an AI/ML model based on the at least one set of RS resources. The term “training reference signal” used herein can refer to the RS applied to construct the data set (e.g., training data set, validation data set, testing data set) that is used for AI/ML model management (e.g., model training, model monitoring, model updating).

In some embodiments, the terminal device 110-1 may receive a downlink (DL) bandwidth part (BWP) configuration. In other words, the configuration information may be the DL BWP configuration. In this case, in some embodiments, the downlink bandwidth part configuration may comprise a training configuration indicating at least one set of RS resources. Alternatively, the downlink bandwidth part configuration may comprise a radio link monitoring configuration indicating the at least one set of RS resources. For example, considering the capability (i.e., support online training) of the terminal device 110-1, the set of training reference signals can be configured as the dedicated (or UE specific) parameter of a DL BWP or carrier component (CC). The training RS includes one or more RS resource sets which includes one or more RS resources. For example, for the terminal device 110-1, a configuration for training (e.g., TrainingConfig, ModelConfig) may be configured in a DL BWP. In some embodiments, the training RS may be configured in the training configuration. Alternatively, the training RS can be configured in radio link monitoring configuration.

In some embodiments, the configuration information may be transmitted in a radio resource control (RRC) signaling. Alternatively, the configuration information may be transmitted in media access control control element (MAC CE). In some other embodiments, the configuration information may be transmitted in downlink control information (DCI).

In some embodiments, the set of training RS may be one or more of: a set of CSI-RSs, a set of SSBs, a set of positioning reference signals (PRSs), or a setoff sounding reference signals (SRSs). For example, if the training of the AI/ML model relates to CSI feedback enhancement (e.g., CSI compression, CSI prediction), CSI-RS overhead reduction may need to collect data based on CSI-RS. The training of the AI/ML model related to positioning may need to collect data based on CSI-RS, PRS or SRS. The training of the AI/ML model related to beam management needs to collect data based on CSI-RS or SSB.

Alternatively, the terminal device 110-1 may receive a configuration of CSI report. In other words, the configuration information may comprise the configuration of CSI report. In this case, in some embodiments, the configuration of CSI report indicates the at least one set of RS resources. Alternatively, the configuration of CSI report indicates a report quantity which indicates that the CSI reported is not required to be reported. For example, the set of training reference signals can be triggered by configuring, activating or indicating a CSI report associated with the set of training reference signals. In some embodiments, the set of training reference signals may be configured in the configuration of the CSI report (i.e., CSI-ReportConfig). Alternatively or in addition, the set of training reference signals may be configured in CSI-ResourceConfig in CSI-ReportConfig. In some embodiments, since the set of training reference signals is triggered based on the CSI report and the information obtained by the set of training reference signals does not need to be reported, the terminal device 110-1 may expect that the report quantity of the CSI report is set to “None”, that is, that CSI report does not require anything to be reported. The time domain type of the CSI report can be periodic (P), semi-persistent (SP) or aperiodic (AP). In some embodiments, period of the CSI-RS/SSB resource may configured by the network device 120. For example, it can be determined based on the above mentioned first capability reported by the terminal device 110-1. As discussed above, the first capability may be used to indicate the time delay of processing AI/ML related data and (or) AI/ML model training/updating. For example, the period is higher than or equal to the time delay indicated by the first capability.

In some embodiments, the terminal device 110-1 may determine a set of reference signals for a set of candidate beams based on the set of training reference signals. For example, if the terminal device 110-1 is not configured with the set of reference signals for the set of candidate beams, the terminal device 110-1 may determine the set of reference signals for the set of candidate beams based on the set of training reference signals. Alternatively, if the terminal device 110-1 is configured with the set of training reference signals, the terminal device 110-1 may determine the set of reference signals for the set of candidate beams based on the set of training reference signals. In some other embodiments, if the set of training reference signals is applied for the AI/ML model corresponding to beam management, the terminal device 110-1 may determine the set of reference signals for the set of candidate beams based on the set of training reference signals. In this way, it can reduce overhead caused by configuring the RSs of candidate beams.

In some embodiments, the terminal device 110-1 may determine the at least one set of RS resources associated with a CSI report. For example, in some embodiments, if the configuration information comprises an enable parameter which indicates the terminal device to determine the set of training reference signals, the terminal device 110-1 may determine the at least one set of RS resources associated with the CSI report. Alternatively, if the configuration information does not comprise the set of RS resources, the terminal device 110-1 may determine the at least one set of RS resources associated with the CSI report. The terminal device 110-1 may also determine the set of training reference signals based on the at least one set of RS resource. For example, the terminal device 110-1 may determine the set of training reference signals based on CSI-RS/SSB resource(s) associated with the CSI report. Further, the CSI-RS/SSB resource and the CSI report need to satisfy the following criteria.

In some embodiments, if the AI/ML model corresponds to at least one of: CSI-feedback enhancement, CSI-RS overhead reduction, or positioning, the CSI report may comprise CSI or compressed CSI. The CSI report comprising the CSI or compressed CSI means that the CSI report is configured for reporting CSI. For example, for determining the set of training reference signals applied for the AI/ML model corresponding to CSI feedback enhancement, CSI-RS overhead reduction or positioning, the CSI report may be configured for reporting CSI (e.g., CSI-RS resource indicator (CRI), rand indicator (RI), lawful intercept (L1), precoding matrix indicator (PMI), channel quality indicator (CQI)) or compressed CSI (e.g., compressed bits). For example, the report quantity of the CSI report is set to “CRI-RI-PMI-CQI” or “compressed bits”.

Alternatively, if the AI/ML model corresponds to beam management, the CSI report may comprise beam information or may be configured not to report. For example, for determining the set of training reference signals applied for models corresponding to beam management, the CSI report may be configured for reporting beam (i.e., beam and corresponding beam quality) or none. For example, the report quantity of the CSI report is set to “CRI-L1-RSRP”, “SSBRI-L1-RSRP” or “None”.

In some embodiments, the terminal device 110-1 may determine the at least one set of RS resources based on the CSI-RS/SSB resources that are used as the RSs of candidate beams, especially for determining the training RS applied for models corresponding to beam management. Specially, the reference signals of candidate beams refer to the set of P CSI-RS/SSB resources configured by candidateBeamRSList1 or candidateBeamRSList2.

In some embodiments, the time domain type of the CSI-RS resource is P or SP. If the time domain type of the CSI-RS resource associated with the CSI report (e.g., AP CSI report) is AP, the training RS can be determined according to a P CSI-RS resource or SSB resource associated with the AP CSI-RS resource. For example, it can be a periodic RS (e.g., CSI-RS, SSB) resource configured with Quasi-co location (QCL)-Type set to ‘typeD’ in the TCI state or the QCL assumption associated with the AP CSI-RS resource, which can be called “a periodic QCL-TypeD RS of the AP CSI-RS resource” for short. In some embodiments, the CSI-RS/SSB resource may be configured for channel measurement.

Different use cases (or different AI/ML models applied for different functions) have different requirements for training data (e.g., input and output). In order to obtain the training data required for a specific use case, the training RS (e.g., CSI-RS, SSB) may need to satisfying some criteria, that is, if the CSI-RS or (and) SSB resource(s) are configured as the training RS, the CSI-RS or SSB resource(s) need to satisfying the some criteria. Examples of the criteria are described below.

For example, for CSI feedback enhancement (e.g., CSI compression) and positioning (i.e., for determining the set of training reference signals applied for the AI/ML model corresponding to or applied for CSI feedback enhancement and positioning), the channel information in all resource elements (REs) within a slot may need to be used as training data of the AI/ML model for CSI feedback enhancement.

In some embodiments, if the AI/ML model corresponds to CSI feedback enhancement, the at least one set of RS resources may fulfill a first condition where reference signal resources in the at least one set of RS resources occupy a most number of resource elements within a slot or a physical resource block. For example, in order to obtain the most complete and accurate channel information (in all REs within a slot), the CSI-RS resource may occupy the most number of REs within a slot/PRB. For example, assuming that the maximum number of (antenna) ports of the CSI-RS that can be supported (MaxNumPortofCSI-RS for short) is 32, the CSI-RS resource(s) need to be configured with 32 ports and fD-CDM2 (i.e., type of CDM). Alternatively or in addition, if the AI/ML model corresponds to CSI feedback enhancement, the at least one set of RS resources may fulfill a second condition where a number of ports of the at least one set of RS resources equals to a maximum number of ports for CSI-RS. In other words, the number of ports of the CSI-RS resource may equal to MaxNumPortofCSI-RS. In some other embodiments, if the AI/ML model corresponds to CSI feedback enhancement, the at least one set of RS resources may fulfill a third condition where the number of ports of the at least one set of RS resources is not smaller than a first threshold number. For example, the number of ports of the CSI-RS resource CSI-RS may be higher than or equal to a first threshold. The first threshold refers to a number of ports (e.g., 1, 2, 4, 8, 12, 16, 24, 32) and is lower than or equal to MaxNumPortofCSI-RS.

In some embodiments, if the AI/ML model corresponds to CSI-RS overhead reduction, the at least one set of RS resources may fulfill a fourth condition where the number of ports of the at least one set of RS resources is not smaller than a maximum number of ports that the AI/ML model applied for CSI overhead reduction. For example, for CSI-RS overhead reduction, the number of ports of the CSI-RS resource may be higher than or equal to the maximum number of ports that the AI/ML model(s) applied for CSI overhead reduction can estimate. For example, there are 2 models corresponding to CSI overhead reduction. Outputs of the 2 models are 8 ports and 16 ports respectively, i.e., they can estimate the CSIs corresponding to 8 ports and 16 ports respectively. In this case, the number of ports of the CSI-RS resource is configured as 16. Alternatively, if the AI/ML model corresponds to CSI-RS overhead reduction, the at least one set of RS resources may fulfill a fifth condition where the number of ports of the at least one set of RS resources is a first predetermined number. For example, the number of ports of the CSI-RS resource may equal to MaxNumPortofCSI-RS.

Alternatively, if the AI/ML model corresponds to beam management, the at least one set of RS resources may fulfill a sixth condition where the number of reference signal resources in the at least one set of RS resources is not smaller than a maximum number of beam that the AI/ML model applied for beam prediction. For example, for beam management, the set of training reference signals may include one or more CSI-RS resource sets configured with repetition (a higher layer parameter). Furthermore, in order to save unnecessary CSI-RS overhead, the number of ports of the CSI-RS resource may be 1 or 2. The training RS needs to include at least N CSI-RS/SSB resource(s). In some embodiments, the value of N is higher than or equal to the maximum number of beams that the AI/ML model(s) applied for beam prediction can estimate. For example, there are 2 models applied for beam prediction. Outputs of the 2 models are 32 beams and 64 beams respectively, i.e., they can estimate the beam qualities of the 32 beams and 64 beams respectively. In this case, the training RS need to include 64 beams. Alternatively, if the AI/ML model corresponds to beam management, the at least one set of RS resources may fulfill a seventh condition where the number of RS resources equals to a maximum number of beams that the terminal device supports. For example, the value of N may equal to the maximum number of beams that can be supported, for example, 64 beams. In some embodiments, if the AI/ML model corresponds to beam management, the at least one set of RS resources may fulfill an eighth condition where the number of reference signal resources equals to a maximum number of reference signal resources that the terminal device supports. For example, the value of N may equal to the maximum number of CSI-RS/SSB resources that can be supported, for example, 192 CSI-RS resources.

In some embodiments, the terminal device 110-1 may determine the AI/ML model based on model information associated with the set of training reference signals. For example, the set of training reference signals or the CSI report (i.e., the CSI report used to trigger the training RS) may be associated with a model information. The model information may be used to indicate the AI/ML model to which the set of training reference signals is applied. In some embodiments, the model information may comprise one or more indicators (indexes or IDs) of one or more AI/ML models. Alternatively, the model information may comprise one or more indicators of one or more AI/ML model groups including a set of AI/ML models. In some other embodiments, the model information may comprise an indicator of one AI/ML model. In this case, the terminal device 110-1 may need to determine all models to which the set of training reference signals is applied based on the indicated AI/ML model. For example, all AI/ML models belong to the same model group but only one out of the model group is indicated.

Alternatively, the terminal device 110-1 may determine model information associated with the set of training reference signals based on usage information associated with the set of training reference signals. In this case, the terminal device 110-1 may determine the AI/ML model based on the model information. For example, the set training reference signals or the CSI report may be associated with usage information. The usage information can be used to indicate the usage (or purpose, function) of the set of training reference signals, e.g., CSI feedback (CSI compression, CSI prediction), CSI overhead reduction, beam management (beam prediction in spatial/time domain) or positioning. The terminal device 110-1 can then determine the model information according to the models corresponding to the usage (or the models required to complete the function). In some embodiments, if the terminal device 110-1 is not indicated with the model information, terminal device 110-1 can determine the model information based on the usage information.

In some embodiments, the configuration information may comprise a configuration of a CSI report. In this case, the terminal device 110-1 may determine the AI/ML model based on a report quantity of the CSI report. In other words, the terminal device 110-1 can determine which AI/ML model the set of training reference signals is applied for based on the report quantity of the CSI report that is used to trigger the set of training reference signals. For example, if the CSI report is configured for reporting the CSI or compressed bits, the terminal device 110-1 can assume that the set of training reference signals is applied to the models corresponding to CSI feedback enhancement, CSI-RS overhead reduction or position. Alternatively, if the CSI report is configured for reporting beam quality or none, the terminal device 110-1 can assume the training RS is applied to the models corresponding to beam management. In some other embodiments, which of the models the training RS is applied to depends on the implementation of the UE side.

At block 430, the terminal device 110-1 manages the AI/ML model based on the set of training reference signals. For example, the terminal device 110-1 may update the AI/ML model based on the set of training reference signals. Alternatively, the terminal device 110-1 may train the AI/ML model based on the set of training reference signals. In other embodiments, the terminal device 110-1 may test the AI/ML model based on the set of training reference signals.

Considering the set of training reference signals is applied to construct the training data set, and the training set may be applied for model training or model updating. Therefore, the set of training reference signals may be associated with some information related to model training or model updating. In some embodiments, the configuration information comprises a data set size or a step size. The data set size may indicate a size of data set. The step size may indicate a frequency of updating the AI/ML model. In this case, the terminal device 110-1 may determine the size of data set and/or the frequency of updating corresponding to the AI/ML model based on the configuration information. For example, the data set size or the step size can refer to an integer that is larger than or equal to 0. For example, assuming that the size and the step size are set to 10 and 2 respectively. If the set of training reference signal is used to construct the training data set, the terminal device 110-1 may need to collect 10 data to perform model training. And after updating 2 data out of the 10 data each time, the terminal device 110-1 may perform the next training (i.e., model updating). “1 data” means that a CSI-RS/SSB transmission corresponding to the P/SP CSI-RS/SSB resource set(s) used as the training RS.

Alternatively, the data set size or the step size can refer to a duration, which may be integral multiple of the period of the CSI-RS/SSB resource set used as the training RS. For example, the terminal device 110-1 may construct the training data set by using the CSI-RS/SSB resources during the duration corresponding to the data set size and perform model training. And, the terminal device 110-1 may update the training data set by using the CSI-RS/SSB resources during the duration corresponding to the step size and perform model updating. In some embodiments, the terminal device 110-1 may report a second capability and/or a third capability. The second capability may indicate a minimum size of the data set required by the terminal device 110-1 to perform training. The third capability may indicate a maximum size of the data set required by the terminal device 110-1 to perform AI/ML model training. In this case, the network device 120 may can determine the data set size based on the second capability and/or the third capability reported by the terminal device 110-1. Alternatively, the terminal device 110-1 may report to the network device 120 a fourth capability indicating a minimum delay required by the terminal device 110-1 to perform AI/ML model training. In this case, the network device 120 may determine the data set size based on the fourth capability.

In some embodiments, the terminal device 110-1 may upload the AI/ML model. The terminal device 110-1 or the network device 120 can apply the trained or updated AI/ML model from the symbol after a predefined time after receiving the last training RS within or during the duration indicated by the data set size or the step size. The predefined time may be determined according to at least one of the fourth capability, a fifth capability indicating the time delay of uploading or downloading model (from the edge cloud or core network). In this way, the terminal device can clearly know when to construct the training data set, model training and model updating. And the network device can know when to obtain the trained or updated model without indication from the UE.

In some embodiments, the configuration information comprises second information which indicates a type of the set of training reference signals. For example, the training RS (or the CSI report) may be associated with the second information. The second information can be used to indicate the type of the training RS, e.g., training, validation, testing. In other words, it is used to indicate which process is the training RS applied to in model management, e.g., model training, model updating, model monitoring. For example, if the terminal device 110-1 is provided with the second information indicating model training (or updating), the terminal device 110-1 can assume that the training RS is used as the RS applied for perform model training/updating. If the terminal device 110-1 is provided with the second information indicating model monitoring, the terminal device 110-1 can assume that the training RS is used as the (monitoring) RS applied for perform model monitoring. It means that the terminal device 110-1 can determine which processes in beam management need to be performed according to the second information.

In some embodiments, the terminal device 110-1 may determine a type of management of the AI/ML model based on the second information. In some embodiments, the type of management of AI/ML model may comprise on or more of: updating the AI/ML model, monitoring the AI/ML model, testing the AI/ML model or training the AI/ML model. For example, the terminal device 110-1 can determine the type of the training RS according to the data set size or the step size associated with the training RS. Specifically, if the terminal device 110-1 is provided with the data set size or the step size, the terminal device 110-1 can assume that the training RS is used as the RS applied for perform model training/updating, otherwise, the terminal device 110-1 can assume that the training RS is used as the (monitoring) RS applied for perform model monitoring. In this way, the terminal device can clearly know the type of the training RS, e.g., which kind of data set is the training RS applied to construct, which process is the training RS applied to in model management.

In some embodiments, a mechanism similar to beam failure recovery (BFR) reporting mechanism (especially for second cell, SCell) can be considered. For example, the terminal device 110-1 may transmit a scheduling request (SR) to the network device 120. For example, the terminal device 110-1 can use a PUCCH transmission carrying a new SR to indicate the event that the model is trained/updated or the model performance is deteriorated. The new SR may correspond to a dedicated SR ID of the event.

The network device 120 may schedule PUSCH resources. For example, after receiving the PUCCH, the network device 120 can schedule UL resource (PUSCH) for the terminal device 110-1. And the terminal device 110-1 can report the information related to the trained/updated/deteriorated model in the scheduled PUSCH resource.

The terminal device 110-1 may transmit a MAC CE to the network device 120. For example, a new MAC-CE can be introduced. The MAC-CE may be used to indicate at least one of the model information corresponding to the trained/updated/deteriorated model, and third information. The third information may be used to indicate the type of management (e.g., trained, updated or deteriorated) corresponding to model indicated by the MAC-CE. In other words, the terminal device 110-1 can transmit the MAC-CE in the scheduled PUSCH resource to inform the network device 120 the trained/updated/deteriorated AI/ML model.

After K (K>=0) symbols from a last symbol of a PDCCH reception with a DCI format scheduling a PUSCH transmission with a same HARQ process number as for the transmission of the first PUSCH and having a toggled NDI field value, the terminal device 110-1 and the network device 120 may apply the managed AI/ML model. Alternatively, the terminal device 110-1 and the network device 120 may stop applying the managed AI/ML model. For example, the terminal device 110-1 and the network device 120 can assume that the indicated model (e.g., the deteriorated model indicated by the MAC-CE) cannot be applied, or the model failures, or the model is invalid.

FIG. 5 shows a flowchart of an example method 500 in accordance with an embodiment of the present disclosure. The method 500 can be implemented at any suitable devices. Only for the purpose of illustrations, the method 500 can be implemented at a network device 120 as shown in FIG. 1.

In some embodiments, the network device 120 may receive one or more capabilities of the terminal device 110-1 from the terminal device 110-1. The one or more capabilities at least indicate that the terminal device 110-1 supports a data processing model. The data processing model can be an AI/ML model. The term “AI/ML model” used herein can refer to a program or algorithm that utilizes a set of data that enables it to recognize certain patterns. This allows it to reach a conclusion or make a prediction when provided with sufficient information. Generally, the AI/ML model can be a mathematical algorithm that is “trained” using data and human expert input to replicate a decision an expert would make when provided that same information.

In some embodiments, the capabilities can indicate a capability of supporting AI/ML. In some embodiments, the capabilities can indicate a capability of supporting beam management based on AI/ML. Alternatively or in addition, the capabilities can indicate a capability of supporting CSI feedback based on AI/ML. Additionally, the capabilities may indicate that the terminal device 110-1 supports a capability of supporting DMRS based on AI/ML. In some other embodiments, the capabilities may indicate that the terminal device 110-1 supports a capability of supporting CSI-RS based on AI/ML. In some embodiments, the capabilities may comprise a first capability. In some embodiments, the first capability may indicate a first time delay of processing AI/ML related data. Alternatively or in addition, the first capability may indicate a second time delay of updating the AI/ML model.

At block 510, the network device 120 transmits configuration information to the terminal device 110-1. The configuration information comprises at least one set of RS resources.

In some embodiments, the network device 120 may transmit a downlink (DL) bandwidth part (BWP) configuration to the terminal device 110-1. In other words, the configuration information may be the DL BWP configuration. In this case, in some embodiments, the downlink bandwidth part configuration may comprise a training configuration indicating at least one set of RS resources. Alternatively, the downlink bandwidth part configuration may comprise a radio link monitoring configuration indicating the at least one set of RS resources. For example, considering the capability (i.e., support online training) of the terminal device 110-1, the set of training reference signals can be configured as the dedicated (or UE specific) parameter of a DL BWP or carrier component (CC). The training RS includes one or more RS resource sets which includes one or more RS resources. For example, for the terminal device 110-1, a configuration for training (e.g., TrainingConfig, ModelConfig) may be configured in a DL BWP. In some embodiments, the training RS may be configured in the training configuration. Alternatively, the training RS can be configured in radio link monitoring configuration.

In some embodiments, the configuration information may be transmitted in a radio resource control (RRC) signaling. Alternatively, the configuration information may be transmitted in media access control control element (MAC CE). In some other embodiments, the configuration information may be transmitted in downlink control information (DCI).

In some embodiments, the set of training RS may be one or more of: a set of CSI-RSs, a set of SSBs, a set of positioning reference signals (PRSs), or a setoff sounding reference signals (SRSs). For example, if the training of the AI/ML model relates to CSI feedback enhancement (e.g., CSI compression, CSI prediction), CSI-RS overhead reduction may need to collect data based on CSI-RS. The training of the AI/ML model related to positioning may need to collect data based on CSI-RS, PRS or SRS. The training of the AI/ML model related to beam management needs to collect data based on CSI-RS or SSB.

Alternatively, the network device 120 may transmit a configuration of CSI report to the terminal device 110-1. In other words, the configuration information may comprise the configuration of CSI report. In this case, in some embodiments, the configuration of CSI report indicates the at least one set of RS resources. Alternatively, the configuration of CSI report indicates a report quantity which indicates that the CSI reported is not required to be reported. For example, the set of training reference signals can be triggered by configuring, activating or indicating a CSI report associated with the set of training reference signals. In some embodiments, the set of training reference signals may be configured in the configuration of the CSI report (i.e., CSI-ReportConfig). Alternatively or in addition, the set of training reference signals may be configured in CSI-ResourceConfig in CSI-ReportConfig. In some embodiments, since the set of training reference signals is triggered based on the CSI report and the information obtained by the set of training reference signals does not need to be reported, the terminal device 110-1 may expect that the report quantity of the CSI report is set to “None”, that is, that CSI report does not require anything to be reported. The time domain type of the CSI report can be periodic (P), semi-persistent (SP) or aperiodic (AP). In some embodiments, period of the CSI-RS/SSB resource may configured by the network device 120. For example, it can be determined based on the above mentioned first capability reported by the terminal device 110-1. As discussed above, the first capability may be used to indicate the time delay of processing AI/ML related data and (or) AI/ML model training/updating. For example, the period is higher than or equal to the time delay indicated by the first capability.

At block 520, the network device 120 transmits a set of training reference signals to the terminal device 110-1. In some embodiments, the set of training reference signals may comprise a set of CSI-RSs. Alternatively or in addition, the set of training reference signals may comprise a set of SSBs. The set of training reference signals may comprise a set of PRSs. In some other embodiments, the set of training reference signals may comprise a set of SRSs.

In some embodiments, the configuration information comprises a data set size or a step size. The data set size may indicate a size of data set. The step size may indicate a frequency of updating the AI/ML model. For example, the data set size or the step size can refer to an integer that is larger than or equal to 0. For example, assuming that the size and the step size are set to 10 and 2 respectively. If the set of training reference signal is used to construct the training data set, the terminal device 110-1 may need to collect 10 data to perform model training. And after updating 2 data out of the 10 data each time, the terminal device 110-1 may perform the next training (i.e., model updating). “1 data” means that a CSI-RS/SSB transmission corresponding to the P/SP CSI-RS/SSB resource set(s) used as the training RS.

Alternatively, the data set size or the step size can refer to a duration, which may be integral multiple of the period of the CSI-RS/SSB resource set used as the training RS. For example, the terminal device 110-1 may construct the training data set by using the CSI-RS/SSB resources during the duration corresponding to the data set size and perform model training. And, the terminal device 110-1 may update the training data set by using the CSI-RS/SSB resources during the duration corresponding to the step size and perform model updating. In some embodiments, the terminal device 110-1 may report a second capability and/or a third capability. The second capability may indicate a minimum size of the data set required by the terminal device 110-1 to perform training. The third capability may indicate a maximum size of the data set required by the terminal device 110-1 to perform AI/ML model training. In this case, the network device 120 may can determine the data set size based on the second capability and/or the third capability reported by the terminal device 110-1. Alternatively, the terminal device 110-1 may report to the network device 120 a fourth capability indicating a minimum delay required by the terminal device 110-1 to perform AI/ML model training. In this case, the network device 120 may determine the data set size based on the fourth capability.

In some embodiments, the terminal device 110-1 or the network device 120 can apply the trained or updated AI/ML model from the symbol after a predefined time after receiving the last training RS within or during the duration indicated by the data set size or the step size. The predefined time may be determined according to at least one of the fourth capability, a fifth capability indicating the time delay of uploading or downloading model (from the edge cloud or core network). In this way, the terminal device can clearly know when to construct the training data set, model training and model updating. And the network device can know when to obtain the trained or updated model without indication from the UE.

In some embodiments, the configuration information comprises second information which indicates a type of the set of training reference signals. For example, the training RS (or the CSI report) may be associated with the second information. The second information can be used to indicate the type of the training RS, e.g., training, validation, testing. In other words, it is used to indicate which process is the training RS applied to in model management, e.g., model training, model updating, model monitoring.

In some embodiments, a mechanism similar to beam failure recovery (BFR) reporting mechanism (especially for second cell, SCell) can be considered. For example, the network device 120 may receive a scheduling request (SR) from the terminal device 110-1. For example, a PUCCH transmission carrying a new SR may be used to indicate the event that the model is trained/updated or the model performance is deteriorated. The new SR may correspond to a dedicated SR ID of the event.

The network device 120 may schedule PUSCH resources. For example, after receiving the PUCCH, the network device 120 can schedule UL resource (PUSCH) for the terminal device 110-1. And the terminal device 110-1 can report the information related to the trained/updated/deteriorated model in the scheduled PUSCH resource.

The network device 120 may receive a MAC CE from the terminal device 110-1. For example, a new MAC-CE can be introduced. The MAC-CE may be used to indicate at least one of the model information corresponding to the trained/updated/deteriorated model, and third information. The third information may be used to indicate the type of management (e.g., trained, updated or deteriorated) corresponding to model indicated by the MAC-CE. In other words, the terminal device 110-1 can transmit the MAC-CE in the scheduled PUSCH the resource to inform the network device 120 trained/updated/deteriorated AI/ML model.

After K (K>=0) symbols from a last symbol of a PDCCH reception with a DCI format scheduling a PUSCH transmission with a same HARQ process number as for the transmission of the first PUSCH and having a toggled NDI field value, the network device 120 may apply the managed AI/ML model. Alternatively, the network device 120 may stop applying the managed AI/ML model. For example, the network device 120 can assume that the indicated model (e.g., the deteriorated model indicated by the MAC-CE) cannot be applied, or the model failures, or the model is invalid.

In some embodiments, a terminal device comprises circuitry configured to perform: receiving configuration information from a network device, wherein the configuration information comprises at least one set of reference signal (RS) resources; determining a set of training reference signals for management of an artificial intelligence/machine learning (AI/ML) model based on the at least one set of RS resources; and managing the AI/ML model based on the set of training reference signals.

In some embodiments, the terminal device comprises circuitry configured to perform receiving the configuration information by: receiving a downlink bandwidth part configuration from the network device; and wherein the downlink bandwidth part configuration comprises a training configuration indicating at least one set of RS resources, or wherein the downlink bandwidth part configuration comprises a radio link monitoring configuration indicating the at least one set of RS resources.

In some embodiments, the set of training reference signals comprises at least one of: a set of channel state information reference signals (CSI-RSs), a set of synchronization signal and physical broadcast channel blocks (SSBs), a set of positioning reference signals (PRSs), or a set of sounding reference signals (SRSs).

In some embodiments, the terminal device comprises circuitry configured to perform receiving the configuration information by: receiving a configuration of channel state information (CSI) report from the network device; and wherein the configuration of CSI report indicates the at least one set of RS resources, and wherein the configuration of CSI report indicates a report quantity which indicates that the CSI reported is not required to be reported.

In some embodiments, the terminal device comprises circuitry configured to perform reporting a first capability to the network device, wherein the first capability indicates at least one of: a first time delay of processing AI/ML related data, or a second time delay of updating the AI/ML model.

In some embodiments, the terminal device comprises circuitry configured to perform determining a set of reference signals for a set of candidate beams based on the set of training reference signals, in accordance with a determination that at least one of the followings is fulfilled: the terminal device is not configured with the set of reference signals for the set of candidate beams, the terminal device is configured with the set of training reference signals, or the set of training reference signals is applied for the AI/ML model corresponding to beam management.

In some embodiments, the terminal device comprises circuitry configured to perform determining the set of training reference signals by: determining the at least one set of RS resources associated with a CSI report; and determining the set of training reference signals based on the at least one set of RS resource.

In some embodiments, the terminal device comprises circuitry configured to perform determining the at least one set of RS resources associated with a CSI report comprises: determining the at least one set of RS resources associated with the CSI report, in accordance with a determination that the configuration information comprises an enable parameter which indicates the terminal device to determine the set of training reference signals, or a determination that the configuration information does not comprise the at least one set of RS resources.

In some embodiments, the CSI report comprises CSI or compressed CSI, if the AI/ML model corresponds to at least one of: CSI feedback enhancement, CSI-RS overhead reduction, or positioning.

In some embodiments, the CSI report comprises beam information or is configured not to report, if the AI/ML model corresponds to beam management.

In some embodiments, if the AI/ML model corresponds to CSI feedback enhancement, the at least one set of RS resources fulfills at least one of conditions comprising: a first condition where reference signal resources in the at least one set of RS resources occupy a most number of resource elements within a slot or a physical resource block, a second condition where a number of ports of the at least one set of RS resources equals to a maximum number of ports for CSI-RS, or a third condition where the number of ports of the at least one set of RS resources is not smaller than a first threshold number.

In some embodiments, if the AI/ML model corresponds to CSI-RS overhead reduction, the at least one set of RS resources fulfills at least one of conditions comprising: a fourth condition where the number of ports of the at least one set of RS resources is not smaller than a maximum number of ports that the AI/ML model applied for CSI overhead reduction, or a fifth condition where the number of ports of the at least one set of RS resources is a first predetermined number.

In some embodiments, if the AI/ML model corresponds to beam management, the at least one set of RS resources fulfills at least one of conditions comprising: a sixth condition where the number of reference signal resources in the at least one set of RS resources is not smaller than a maximum number of beam that the AI/ML model applied for beam prediction, a seventh condition where the number of RS resources equals to a maximum number of beams that the terminal device supports, or an eighth condition where the number of reference signal resources equals to a maximum number of reference signal resources that the terminal device supports.

In some embodiments, a type of at least one set of RS resources is persistent or semi-persistent.

In some embodiments, the terminal device comprises circuitry configured to perform determining the AI/ML model based on model information associated with the set of training reference signals.

In some embodiments, the terminal device comprises circuitry configured to perform determining model information associated with the set of training reference signals based on usage information associated with the set of training reference signals; and determining the AI/ML model based on the model information.

In some embodiments, the configuration information comprises a configuration of a CSI report, and the terminal device comprises circuitry configured to perform determining the AI/ML model based on a report quantity of the CSI report.

In some embodiments, the configuration information comprises a data set size or a step size, wherein the data set size indicates a size of data set, and wherein the step size indicates a frequency of updating the AI/ML model; and terminal device comprises circuitry configured to perform obtaining at least one of: a corresponding size of data set or a corresponding frequency of updating model of the AI/ML model based on the configuration information.

In some embodiments, the terminal device comprises circuitry configured to perform reporting, to the network device, at least one of: a second capability or a third capability, wherein the second capability indicates a minimum size of the data set required by the terminal device to perform training and the third capability indicates a maximum size of the data set required by the terminal device to perform AI/ML model training; and wherein the data set size or the step size is determined based on at least one of the second capability or the third capability.

In some embodiments, the terminal device comprises circuitry configured to perform reporting, to the network device, a fourth capability, wherein the fourth capability indicates a minimum delay required by the terminal device to perform AI/ML model training; and wherein the data set size or the step size is determined based on the fourth capability.

In some embodiments, the configuration information comprises second information which indicates a type of the set of training reference signals. In some embodiments, the terminal device comprises circuitry configured to perform determining a type of management of the AI/ML model based on the second information, wherein the type of management of the AI/ML model comprises one of: updating the AI/ML model, monitoring the AI/ML model, testing the AI/ML model, or training the AI/ML model.

In some embodiments, the terminal device comprises circuitry configured to perform transmitting, to the network device, a scheduling request to indicate that the management of the AI/ML model is completed; receiving, from the network device, downlink control information indicating a scheduled resource; and transmitting, to the network device, a media access control control element (MAC CE) which inform the managed AI/ML model, wherein the managed AI/ML model comprise at least one of: an updated AI/ML model, a trained AI/ML model or a deteriorated AI/ML model.

In some embodiments, the terminal device is configured with a predetermined duration. In some embodiments, the terminal device comprises circuitry configured to perform applying the updated AI/ML model after the predetermined duration; or stopping applying the deteriorated AI/ML model after the predetermined duration.

In some embodiments, a network device comprises circuitry configured to perform transmitting, at a network device, configuration information to a terminal device, wherein the configuration information indicates at least one set of reference signal (RS) resources; and transmitting, to the terminal device, a set of training reference signals for management of an artificial intelligence/machine learning (AI/ML) model based on the at least one set of RS resources.

In some embodiments, the network device comprises circuitry configured to perform transmitting the configuration information by: transmitting a downlink bandwidth part configuration to the terminal device; and wherein the downlink bandwidth part configuration comprises a training configuration indicating at least one set of RS resources, or wherein the downlink bandwidth part configuration comprises a radio link monitoring configuration indicating the at least one set of RS resources.

In some embodiments, the set of training reference signals comprises at least one of: a set of channel state information reference signals (CSI-RSs), a set of synchronization signal and physical broadcast channel blocks (SSBs), a set of positioning reference signals (PRSs), or a set of sounding reference signals (SRSs).

In some embodiments, the network device comprises circuitry configured to perform transmitting the configuration information comprises: transmitting a configuration of channel state information (CSI) report to the terminal device; and wherein the configuration of CSI report indicates the at least one set of RS resources, and wherein the configuration of CSI report indicates a report quantity which indicates that the CSI reported is not required to be reported.

In some embodiments, the network device comprises circuitry configured to perform receiving from the terminal device first information indicating a first capability, wherein the first capability indicates at least one of: a first time delay of processing AI/ML related data, or a second time delay of updating the AI/ML model.

In some embodiments, the at least one set of RS resources is persistent or semi-persistent.

In some embodiments, the set of training reference signals is associated with model information indicating the AI/ML model to which the set of training reference signals is applied.

In some embodiments, the set of training reference signals is associated with usage information indicating a usage of the set of training reference signals.

In some embodiments, the configuration information is a configuration of a CSI report.

In some embodiments, the configuration information comprises a data set size or a step size, wherein the data set size indicates a size of data set, and wherein the step size indicates a frequency of updating the AI/ML model.

In some embodiments, the network device comprises circuitry configured to perform receiving, from the terminal device, second information comprising at least one of: a second capability or a third capability, wherein the second capability indicates a minimum size of the data set required by the terminal device to perform training and the third capability indicates a maximum size of the data set required by the terminal device to perform AI/ML model training; and determining the data set size or the step size based on at least one of the second capability or the third capability.

In some embodiments, the network device comprises circuitry configured to perform receiving, from the terminal device, third information comprising a fourth capability, wherein the fourth capability indicates a minimum delay required by the terminal device to perform AI/ML model training; and determining the data set size or the step size based on the fourth capability.

In some embodiments, the configuration information comprises second information which indicates a type of the set of training reference signals fourth information which indicates a type of the set of training reference signals.

In some embodiments, the network device comprises circuitry configured to perform receiving, from the terminal device, a scheduling request to indicate that the management of the AI/ML model is completed; transmitting, to the terminal device, downlink control information indicating a scheduled resource; and transmitting, to the network device, a media access control control element (MAC CE) which inform the managed AI/ML model, wherein the managed AI/ML model comprise at least one of: an updated AI/ML model, a trained AI/ML model or a deteriorated AI/ML model.

In some embodiments, the network device is configured with a predetermined duration. In some embodiments, the network device comprises circuitry configured to perform applying the updated AI/ML model after the predetermined duration; or stopping applying the deteriorated AI/ML model after the predetermined duration.

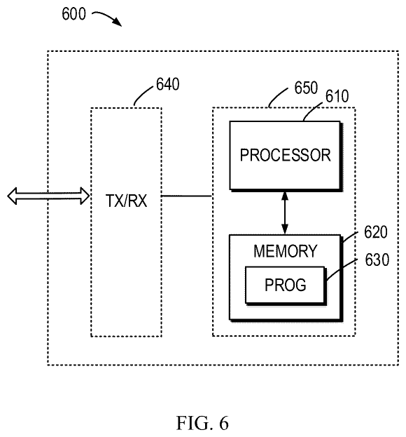

FIG. 6 is a simplified block diagram of a device 600 that is suitable for implementing embodiments of the present disclosure. The device 600 can be considered as a further example implementation of the terminal device 110 as shown in FIG. 1. Accordingly, the device 600 can be implemented at or as at least a part of the terminal device 110. Alternatively, the device 600 can be considered as a further example implementation of the network device 120 as shown in FIG. 1. Accordingly, the device 600 can be implemented at or as at least a part of the network device 120.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 620 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the CNB, Un interface for communication between the CNB and a relay node (RN), or Uu interface for communication between the CNB and a terminal device.

The program 630 is assumed to include program instructions that, when executed by the associated processor 610, enable the device 600 to operate in accordance with the embodiments of the present disclosure, as discussed herein with reference to FIGS. 2 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (Iota) devices, Ultra-reliable and Low Latency Communications (URLLC) devices, Internet of Everything (Iowa) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and Iota applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (Node or NB), an evolved Node (anode or eNB), a next generation Node (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

1. A communication method, comprising:
receiving, at a terminal device, configuration information from a network device, wherein the configuration information comprises at least one set of reference signal (RS) resources;
determining a set of training reference signals for management of an artificial intelligence/machine learning (AI/ML) model based on the at least one set of RS resources; and
managing the AI/ML model based on the set of training reference signals.

2. The method of claim 1, wherein receiving the configuration information comprises:
receiving a downlink bandwidth part configuration from the network device; and
wherein the downlink bandwidth part configuration comprises a training configuration indicating at least one set of RS resources, or
wherein the downlink bandwidth part configuration comprises a radio link monitoring configuration indicating the at least one set of RS resources.

3. (canceled)

4. The method of claim 1, wherein receiving the configuration information comprises:
receiving a configuration of channel state information (CSI) report from the network device; and
wherein the configuration of CSI report indicates the at least one set of RS resources, and
wherein the configuration of CSI report indicates a report quantity which indicates that the CSI reported is not required to be reported.

5. The method of claim 1, further comprising:
reporting a first capability to the network device, wherein the first capability indicates at least one of:
a first time delay of processing AI/ML related data, or
a second time delay of updating the AI/ML model.

6. The method of claim 1, further comprising:
determining a set of reference signals for a set of candidate beams based on the set of training reference signals, in accordance with a determination that at least one of the followings is fulfilled:
the terminal device is not configured with the set of reference signals for the set of candidate beams,
the terminal device is configured with the set of training reference signals, or
the set of training reference signals is applied for the AI/ML model corresponding to beam management.

7. The method of claim 1, wherein determining the set of training reference signals comprises:
determining the at least one set of RS resources associated with a CSI report; and
determining the set of training reference signals based on the at least one set of RS resource.

8. The method of claim 7, wherein determining the at least one set of RS resources associated with a CSI report comprises:
determining the at least one set of RS resources associated with the CSI report, in accordance with a determination that the configuration information comprises an enable parameter which indicates the terminal device to determine the set of training reference signals, or a determination that the configuration information does not comprise the at least one set of RS resources.

9. (canceled)

10. The method of claim 7, wherein the CSI report comprises beam information or is configured not to report, if the AI/ML model corresponds to beam management.

11-12. (canceled)

13. The method of claim 1, wherein if the AI/ML model corresponds to beam management, the at least one set of RS resources fulfills at least one of conditions comprising:
a sixth condition where the number of reference signal resources in the at least one set of RS resources is not smaller than a maximum number of beam that the AI/ML model applied for beam prediction,
a seventh condition where the number of RS resources equals to a maximum number of beams that the terminal device supports, or
an eighth condition where the number of reference signal resources equals to a maximum number of reference signal resources that the terminal device supports.

14. (canceled)

15. The method of claim 1, further comprising:
determining the AI/ML model based on model information associated with the set of training reference signals.

16. The method of claim 1, further comprising:
determining model information associated with the set of training reference signals based on usage information associated with the set of training reference signals; and
determining the AI/ML model based on the model information.

17. The method of claim 1, wherein the configuration information comprises a configuration of a CSI report, and wherein the method further comprises:
determining the AI/ML model based on a report quantity of the CSI report.

18. The method of claim 1, wherein the configuration information comprises a data set size or a step size,
wherein the data set size indicates a size of data set, and
wherein the step size indicates a frequency of updating the AI/ML model; and
wherein the method further comprises:
obtaining at least one of: a corresponding size of data set or a corresponding frequency of updating model of the AI/ML model based on the configuration information.

19. The method of claim 18, further comprising:
reporting, to the network device, at least one of: a second capability or a third capability, wherein the second capability indicates a minimum size of the data set required by the terminal device to perform training and the third capability indicates a maximum size of the data set required by the terminal device to perform AI/ML model training; and
wherein the data set size or the step size is determined based on at least one of the second capability or the third capability.

20. The method of claim 18, further comprising:
reporting, to the network device, a fourth capability, wherein the fourth capability indicates a minimum delay required by the terminal device to perform AI/ML model training; and
wherein the data set size or the step size is determined based on the fourth capability.

21. The method of claim 1, wherein the configuration information comprises second information which indicates a type of the set of training reference signals; and
wherein the method further comprises:
determining a type of management of the AI/ML model based on the second information, wherein the type of management of the AI/ML model comprises one of:
updating the AI/ML model,
monitoring the AI/ML model,
testing the AI/ML model, or
training the AI/ML model.

22. The method of claim 1, further comprising:
transmitting, to the network device, a scheduling request to indicate that the management of the AI/ML model is completed;
receiving, from the network device, downlink control information indicating a scheduled resource; and
transmitting, to the network device, a media access control control element (MAC CE) which inform the managed AI/ML model, wherein the managed AI/ML model comprise at least one of: an updated AI/ML model, a trained AI/ML model or a deteriorated AI/ML model.

23. The method of claim 1, wherein the terminal device is configured with a predetermined duration, and wherein the method further comprises:
applying the updated AI/ML model after the predetermined duration; or
stopping applying the deteriorated AI/ML model after the predetermined duration.

24. A communication method, comprising:
transmitting, at a network device, configuration information to a terminal device, wherein the configuration information indicates at least one set of reference signal (RS) resources; and
transmitting, to the terminal device, a set of training reference signals for management of an artificial intelligence/machine learning (AI/ML) model based on the at least one set of RS resources.

25-38. (canceled)

39. A terminal device comprising:
a processor; and
a memory coupled to the processor and storing instructions thereon, the instructions, when executed by the processor, causing the terminal device to:
receive configuration information from a network device, wherein the configuration information comprises at least one set of reference signal (RS) resources;
determine a set of training reference signals for management of an artificial intelligence/machine learning (AI/ML) model based on the at least one set of RS resources; and
manage the AI/ML model based on the set of training reference signals.

40-41. (canceled)
